(19) United States
(12) Patent Application Publication
(10) Pub. No.: US 2014/0030813 A1
(43) Pub. Date: Jan. 30, 2014

(54) SYSTEM AND METHOD FOR MEASURING HYDRO CARBONATE CONTENT IN MINERALS

(71) Applicant: Paulo Roberto Pinheiro Amaral, Sao Mateus do Sul (BR)

(72) Inventor: Paulo Roberto Pinheiro Amaral, Sao Mateus do Sul (BR)

(73) Assignee: PETROLEO BRASILEIRO S.A. - PETROBRAS, Rio de Janeiro, RJ (BR)

(21) Appl. No.: 14/111,108

(22) PCT Filed: Nov. 18, 2011
(86) PCT No.: PCT/BR2011/000424

§ 371 Date: Oct. 10, 2013

(51) Int. Cl. G01N 22/00

(52) U.S. Cl. CPC G01N 22/00
USPC 436/131; 422/78

(57) ABSTRACT

System for measuring the hydro carbonate content in minerals, particularly pyrobituminous shale minerals, while they pass through the transport or production system, in such a way as to permit the prior adjustment of the processing conditions of said minerals. The system consists of a set of equipment for the measurement of water content, material density and hydrogen content in the mineral, said equipment being combined in such a way as to create a specific time delay between the measurements, in order for the collected data to be micro processed and the processing conditions to be adjusted in real time, based on the calculated hydro carbonate content.

### FIELD OF INVENTION

The current invention refers to a system and method for determining, in a continuous manner, the content of hydro carbonates in sedimentary minerals, such as pyro-bituminous shale and bituminous sands to be submitted to an extraction process by means of pyrolysis or a combustion process, using a specific combination of instrumental techniques. The proposed system is capable of estimating in real time the quantity of hydro carbonates to be processed from the results of the measurement of water content, density and hydrogen content in the mineral transport system directly or in the production system.

### THE BASIS OF THE INVENTION

The conventional measurement of the hydro carbonate content in minerals for its use in extraction mines, for example, is traditionally done with samples that represent only an average of a batch, resulting in operational errors due to the natural variations, which generate a reasonable standard deviation, in some cases reaching 30%. Through improvements in the mixing system of the raw material it would be possible to reduce the batch's standard deviation, but at a prohibitive cost.

The measurement in batches is carried out via an analysis known as the “Fischer Exercise,” which uses a small aluminum retort and a condensation system. The exercise consists of heating the mineral in the retort to the temperature necessary for releasing the hydro carbonates, which are then condensed in a cool system. The hydro carbonates content is determined by the ratio condensed/total quantity of minerals.

Nevertheless, the time necessary for carrying out the exercise, as well as the errors resulting from the sampling, allow only for its results to be employed for modeling the process and for verification of its parameters after the material is processed.

The processing of the minerals, such as shales and other bituminous minerals, is done by heating or burning them in temperature and air quantity conditions and other parameters calculated based on the quantity of hydro carbonates present in the minerals. Therefore, variations in these raw material parameters will require the operational conditions to be constantly adjusted.

The specialized technical literature teaches that there are significant differences between the composition of the hydro carbonates from each reserve of these minerals; however, the characteristics within each reserve, and specifically from each reservoir, are quite homogenous, allowing us to conclude that there is a roughly fixed relationship between the quantity of carbon/hydrogen in the hydro carbonate. Tests carried out in laboratories have proven such a relationship.

Thus, by knowing the water content, density and hydro carbonates present in the raw material, the mineral processing conditions may be determined in advance in such a way as to improve the efficiency of the process. The system proposed by the current invention makes it possible to monitor these parameters in real time, directly in the mineral transport system or production system. With the continuous real time measurement of the content of hydro carbonates before the minerals enter the extraction equipment, it is possible to change the parameters of the process, in order to correct them as significant variations in the raw material are verified.

The invention now proposed is based on combining five consolidated principles
High energy neutrons, known as fast neutrons, have their energy diminished to thermal neutron levels when suffering inelastic collisions with atomic nuclei. This process, known as neutron moderation, occurs with greater severity in lighter elements such as hydrogen and deuterium. The effect of other atoms can, for practical purposes, be disregarded. In minerals such as pyrobituminous shale and bituminous sands, the moderation of fast neutron radiation to thermal neutrons has a quadratic relationship with the quantity of hydrogen, the content of the same being measurable through counting thermal neutrons. Buczkó demonstrated the precision of this technique when applied to asphaltic concretes already in 1975, while Akaho demonstrated its repeatability for various hydro carbonates.
   There exists the possibility of measuring the hydrogen also via the attenuation of fast neutron transmission, with similar results. However, due to the larger quantity of components necessary for the transmission process, it is recommended that the moderation technique via reflection be utilized.
   The gamma radiation interacts with the whole atom, and it is possible to consider that its intensity diminishes in a quadratic relationship with the density and quantity of material in the path of its beam, when we consider a similar chemical composition.
   It is possible to measure the water content in a mineral in a continuous manner by, for example, using microwaves, which, when transmitted through the material, have as their main attenuating factor their resonance with the water molecules in a quadratic relationship with their quantity.
   In the same reserve of pyrobituminous shale or bituminous sand, there is no large variation in the carbon/hydrogen ratio in the same reservoir, which can be compensated by an adequate calibration frequency.

The current invention system carries out the measurement of water content, density and hydrogen content by means of microwaves or another humidity analyzer, gamma radiation or integrating balance and neutron radiation respectively, directly in the mineral transport system or in the production system. The equipment employed for carrying out the measures are known to specialists and employees individually for other applications, supplying instantaneous results, with considerable precision and repeatability. As an example the following documents can be mentioned: U.S. Pat. No. 5,333,493—Moisture content by microwave phase shift and mass/area; U.S. Pat. No. 6,362,477—Bulk material analyzer for on-conveyor or belt analysis; WO 03/021234—Density/level gauge having ultra-low activity gamma-ray source.

The invention utilizes the data collected by this equipment and allows for, by knowing the hydrogen quantity present in the form of water and the total hydrogen content, the estimation of the percentage present in the form of hydro carbonate. Therefore, considering the existence of a fixed relationship between carbon and hydrogen, the hydro carbonate content can be calculated. The monitoring is accompanied in real time via a microprocessor with a dedicated computer program.

### SUMMARY OF THE INVENTION

The current invention is a System and Method for measuring hydro carbonate content in minerals, particularly minerals from pyrobituminous shale, in such a way as to allow the prior adjustment of processing conditions for the aforementioned minerals while they are in the transport or production system.

The system consists of a set of equipment for the measurement of water content, material density and hydrogen content in the mineral, said equipment being combined in such a way as to create a specific time delay between the measurements, in order for the collected data to be micro processed and the processing conditions to be adjusted in real time, based on the calculated hydro carbonate content.

The method for measuring the hydro carbonate content consists of the following steps:
place the pulverized mineral in a transport or production system, letting it go a certain distance to reach its settling capacity aforementioned;
after it goes a certain distance, make the mineral in the transport system pass through the first measurement equipment to determine water content;
after going a certain distance (d1) from the first equipment, make the mineral in the transport system pass through the second measurement equipment to determine its mass flow and density;
after going a certain distance (d2) from the second equipment, make the mineral in the transport system pass through the third measurement equipment to determine its hydrogen content;
synchronize the measurement times of the respective parameters in accordance with the distances to be traveled by the mineral between the equipment and the speed of the transport system;
send the values measured to a microprocessor containing an embedded computer program, in order for the hydro carbonate content to be calculated in real time;
make the adjustments necessary in the processing operation conditions before the mineral is processed.

### BRIEF DESCRIPTION OF THE FIGURES

FIG. 1 shows a simplified schematic representation of the invention system.

FIG. 2 shows a schematic representation of the equipment that measures the content of water in the mineral.

FIG. 3 shows a schematic representation of the equipment that measures the density or mass flow of the mineral.

FIG. 4 shows a schematic representation of the equipment that measures the content of hydrogen in the mineral.

FIG. 5 shows a graphic representation of the data synchronicity.

### DETAILED DESCRIPTION OF THE INVENTION

For a better understanding and evaluation of the current invention for the system and method of measuring hydro carbonate content in minerals, it will be described in detail as part of this report with the support of the figures attached.

As mentioned above, the system consists of a set of equipment for the measurement of the water content, material density and hydrogen content in the mineral, said equipment being combined in such a way as to create a specific time delay between measurements, in order for the collected data to be micro processed and so, in real time, the processing conditions can be adjusted based on the calculated hydro carbonate content.

In general, the method for measuring the hydro carbonate content consists of these steps:
place the pulverized mineral (11) in a transport (10) or production system, letting it go a certain distance (D) to reach its settling capacity aforementioned;
make the mineral in the transport system (10) pass through the first measurement equipment (20) to determine water content, by using, for example, a microwave measurement device;
make the mineral in the transport system (10), after going a certain distance (d1) from the first equipment (20), pass through the second measurement equipment (30) to determine its mass flow or density, via, for example, a gamma ray or X-ray measurement device;
make the mineral in the transport system (10), after going a certain distance (d2) from the second equipment (30), pass through the third measurement equipment (40) to determine its hydrogen content, via, for example, a measurement device for fast neutrons, for example, AmBe or PuBe;
synchronize the measurement times of the respective parameters in accordance with the distances to be traveled (d1 and d2) by the mineral between the equipment and the speed of the transport system;
send the values measured to a microprocessor (50) containing an embedded computer program in order for the hydro carbonate content to be calculated in real time;
make the adjustments necessary in the processing operation conditions before the mineral is processed.

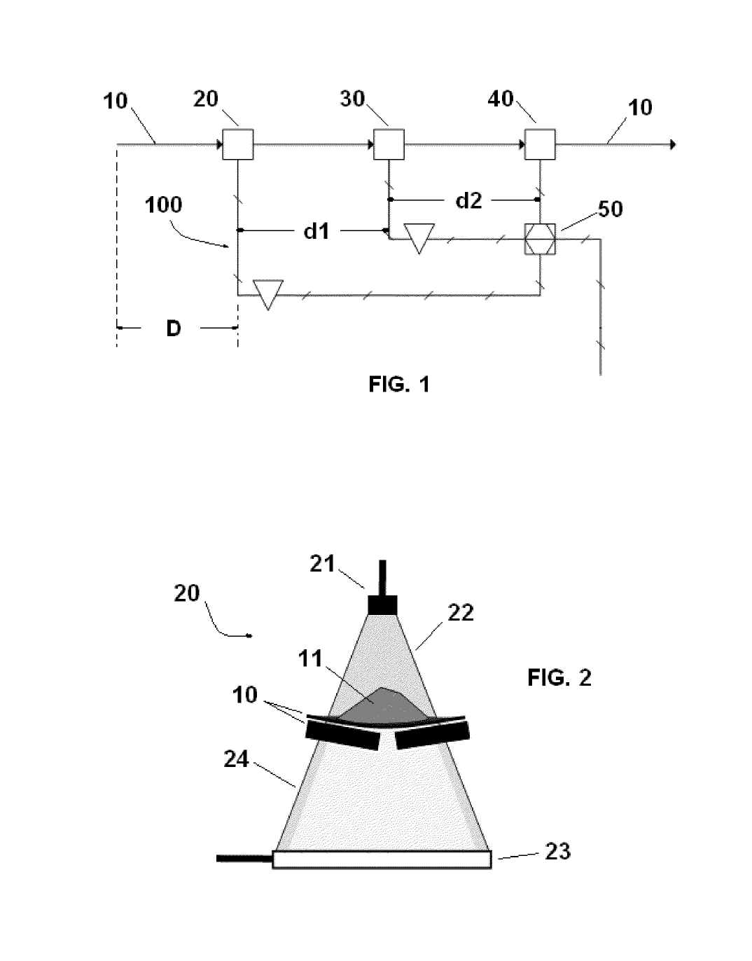

FIG. 1 shows a general flowchart of the invention system (100). As can be observed in this Figure, the operation of the system (100) starts with the entry of the already-pulverized mineral into the transport system (10) or production system, where it will travel a certain distance (D), depending on its settling capacity. The same portion will be prevented from returning and passing more than once through the same measuring equipment.

After a stabilizing run, the mineral is analyzed by the first equipment as to its water content. A microwave measuring device (20) can be used, for example, as shown in detail in FIG. 2. A microwave emitter (21) issues onto the mineral (11) a beam (22) with a frequency equivalent to the natural frequency of the water molecule, ensuring that the water present in the mineral (11) absorbs a portion of the energy of the beam. A sensor (23) located on the opposite side of the emitter (21) performs the measurement for total passing power. The humidity content present in the mineral is then calculated according to the remaining energy (24).

The sensor may be easily calibrated using samples with known humidity values. It is known from the literature that there is an exponential relationship, resulting in an equation of the type:

$$Mp = Mi \cdot {e}^{\frac{- 0 , 693}{a 1 / 2} \cdot am} + Ctea$$

### That is:

$$am = - \frac{{a }_{1 / 2}}{0 , 693} \cdot ln ( \frac{Mp - Ctea}{Mi} )$$

### Where:

### Mp=Passing Microwave.

### Mi=Incident Microwave.

a_{1/2}=Water content semi reducer.
am=Water Quantity.

### Ctea=Constant.

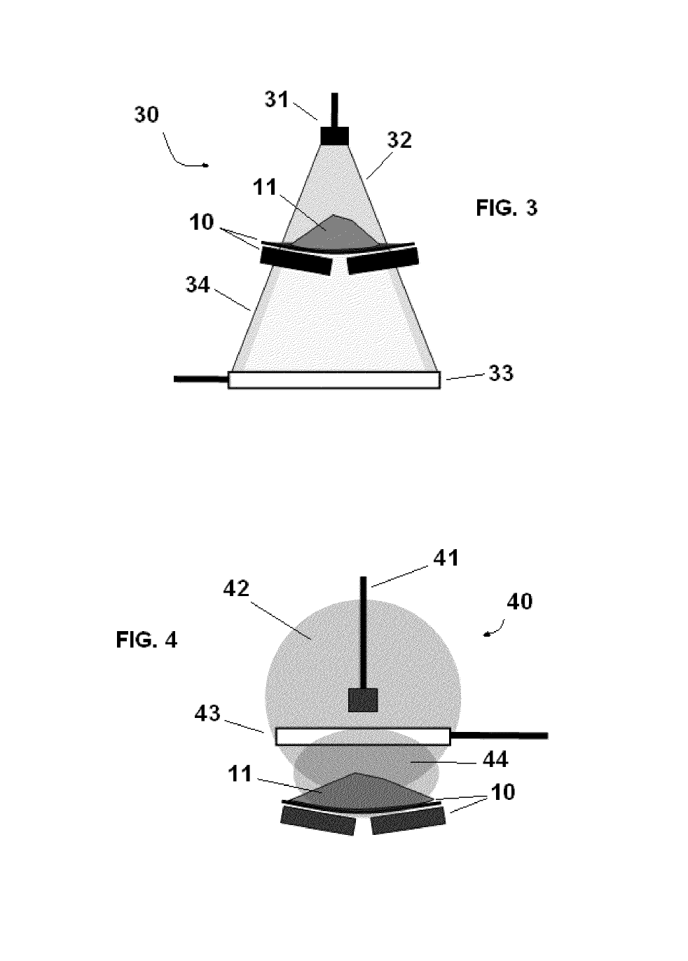

The second equipment (30) consists of a mineral mass flow measurement device that emits gamma radiation through the mineral (10) transport system or production system. A schematic representation of the equipment is shown in FIG. 3.

The gamma radiation (32) is absorbed by the atoms present in the path of the beam (mineral particles). The gamma radiation emitter (31) has its radio isotope defined according to the type of mineral and dimensions of the mineral transport system (10) or production system, it being possible, in some cases, to substitute it for an X-ray source. The attenuated radiation (34) can be detected by a proportional type detector (33) or by a scintillator.

This type of equipment can, in some situations, also be substituted for a conventional integrating balance; however, the reduction of precision caused by this substitution may significantly diminish the precision of the system as a whole. In some more rare cases, a mineral that is distributed in a sufficiently homogenous manner and with little variation in density may eliminate the need for the equipment, whose measurement value can be substituted by a constant for the purposes of calculation in the final equation.

The literature teaches us that the reduction in intensity of the radiation is exponential in relation to the quantity of the material. Thus, the equipment may be easily calibrated, using, for example, mineral blocks of known dimensions and densities, resulting in an equation of the type:

$$Ip = Ii \cdot {e}^{\frac{- 0 , 693}{{q }_{1 / 2}} \cdot qm} + Cteq$$

### That is:

$$qm = - \frac{{q}_{1 / 2}}{0 , 693} \cdot ln ( \frac{Ip - Cteq}{Ii} )$$

### Where:

### Ip=Passing Gamma Radiation.

### Ii=Incident Gamma Radiation.

q_{1/2}=Mineral quantity semi reducer.
qm=Mineral quantity.

### Cteq=Constant.

The third equipment (40), shown in detail in FIG. 4, consists of a device measuring the hydrogen content in the mineral. It consists of a radiation source (41) of fast neutrons, such as, for example, AmBe or PuBe, which emits its beam over the mineral (11) present in the continuous transport system (10). A thermal neutron detector (43) is installed preferably between the source of the radiation (41) and the mineral (11), or next to the radiation source (41). The relationship between the fast neutrons emitted (42), due to the radiation source (41) activity and the quantity of thermal neutrons detected (44), is exponential to the quantity of hydrogen in the mineral. The equipment (40) may be easily calibrated by passing through a portion of the material with known water content and hydro carbonates, resulting in an equation of the type:

$$Nt = Nr \cdot {e}^{\frac{0 , 693}{{h}_{1 / 2}} \cdot hm} + Cteh$$

### That is:

$$hm = \frac{{h}_{1 / 2}}{0 , 693} \cdot ln ( \frac{Nt - Cteh}{Nr} )$$

### Where:

### Nr=Quantity of Fast Neutrons.

### Nt=Quantity of Thermal Neutrons.

h_{1/2}=Quantity of hydrogen that moderates half of the fast neutrons.
hm=Quantity of hydrogen.

### Cteh=Constant.

From the data of these three sets of equipment the system (100) to measure the content of hydro carbonates in minerals, subject of the current invention with the help of a microprocessor (50)—see FIG. 1, which uses an embedded computer program (software) to calculate in real time the quantity of hydro carbonates present in the mineral, based on the following equation:

$$HC = ( hm - am ) * ( 1 + C ( CH ) / qm )$$

$$HC = \frac{( hm - am ) \cdot ( 1 + {C}_{CH} )}{qm}$$

### Where:

HC=Hydro carbonate content in the mineral.
hm=Quantity of hydrogen.
am=Water Quantity.
C_{CH}=Constant Hydrogen Carbon ratio.
Qm=Quantity of mineral.

The constants Ctea, Cteq and Cteh are related to the attenuation or moderation of the radiation by the mineral transport (10) or production system and can be obtained by monitoring the instruments without passing through any mineral.

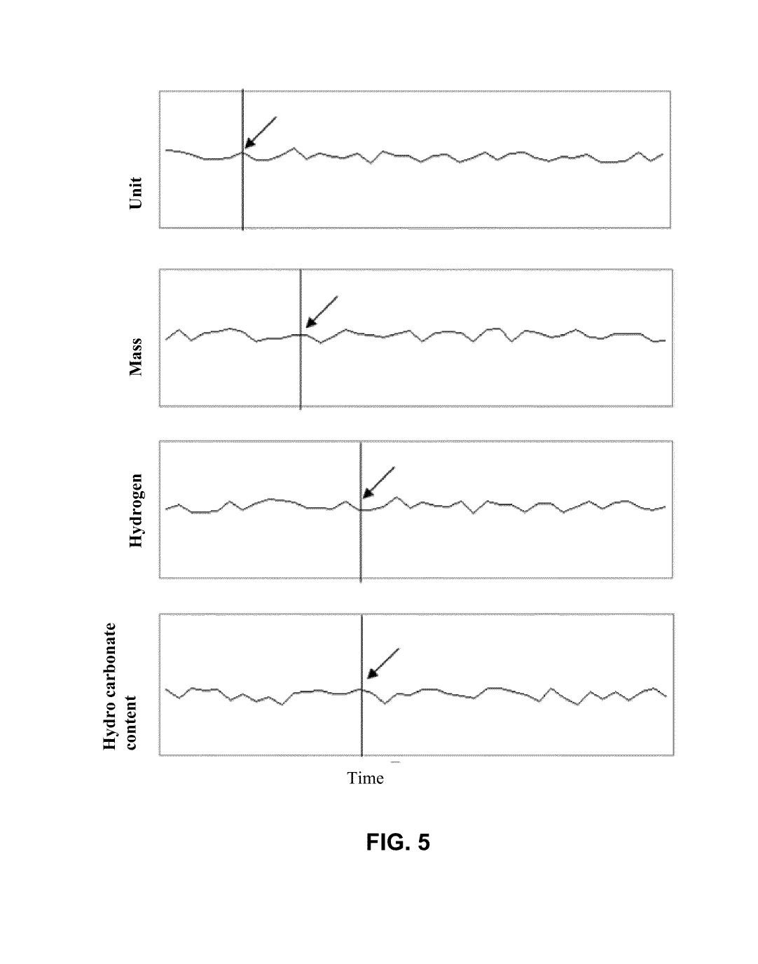

A determining factor for the adjustment of the system (100) is the synchronicity between the data measured by each equipment, because the speed of the transport or production system and the distance between each instrument must be considered. The graphics shown in FIG. 5, generated by the microprocessor (50), show that to obtain the hydro carbonate content (HC) the instantaneous reading of the installed instrument that measures hydrogen (40) is required, together with the values from the water content measurement device (20) and the mass flow (30) measurement device from previous times, which are equivalent to the speed of displacement in the system.

The data obtained directly are instantaneous values and can be integrated in any range of time, in case the data are stored in the microprocessor (50), resulting in average values and deviations of the variables.

The order of installation of the equipment does not interfere with the final results, since the system can compensate for this sequence in its programming or hardware.

An example of the application of the system is the measurement of hydro carbonate content in pyrobituminous minerals. Real-time measurement results in knowing the oil content in each stage of the pyrolysis reaction inside the processing unit, allowing for the adjustment of its parameters in such a way as to obtain maximum productivity. Based on the history of operation losses in the unit, it is possible to create an increase of 2% to 6% in the production of equivalent oil.

It is becoming evident for the specialists in this field that changes and adaptations can be made in the system as a function of the type of mineral treated, as well as different combinations of the equipment when applying the method, without abandoning the innovative concept described here.

1. SYSTEM FOR MEASURING HYDRO CARBONATE CONTENT IN MINERALS, characterized by comprising a set of equipment for measuring water content, material density and hydrogen content in the mineral. Said equipment is combined in such a way as to create a specific time delay between measurements, so that the collected data can then be micro processed, and so that, in real time, the conditions for the processing of the mineral can be adjusted based on the calculated hydro carbonate content.

2. SYSTEM FOR MEASURING HYDRO CARBONATE CONTENT IN MINERALS, according to claim 1, characterized by the water content determined with the help of a microwave measurement device.

3. SYSTEM FOR MEASURING HYDRO CARBONATE CONTENT IN MINERALS, according to claim 1, characterized by the density of the material determined by a mineral mass flow measurement device, selected from those that emit gamma radiation or X-rays.

4. SYSTEM FOR MEASURING HYDRO CARBONATE CONTENT IN MINERALS, according to claim 1, characterized by the hydrogen content determined by a radiation source of fast neutrons, such as AmBe or PuBe.

5. SYSTEM FOR MEASURING HYDRO CARBONATE CONTENT IN MINERALS, according to claim 1, characterized by the hydro carbonate content calculated in real time with the help of a microprocessor, which utilizes an embedded computer program (software).

6. SYSTEM FOR MEASURING HYDRO CARBONATE CONTENT IN MINERALS, according to claim 1, characterized by the synchronicity between the data measured by each set of equipment, considering the speed of the transport system or production system and the distance between each set of equipment.

7. SYSTEM FOR MEASURING HYDRO CARBONATE CONTENT IN MINERALS, according to claim 1, characterized by measurement in real time of oil content in each stage of the pyrolysis reaction inside the processing unit, allowing for the adjustment of its parameters in such a way as to obtain maximum productivity.

8. SYSTEM FOR MEASURING HYDRO CARBONATE CONTENT IN MINERALS, according to claim 1, characterized by submitting bituminous shale minerals to the pyrolysis process.

9. METHOD FOR MEASURING HYDRO CARBONATE CONTENT IN MINERALS, characterized by comprising the following stages:
place the pulverized mineral (11) in a transport (10) or production system, letting it go a certain distance (D) to reach its settling capacity aforementioned
make the mineral (11) in the transport system (10) pass through the first measurement equipment (20), to determine water content by, for example, using a microwave measurement device;
make the mineral (11) in the transport system (10), after going a certain distance (d1) from the first equipment (20), pass through a second set of measurement equipment (30), to determine its mass flow or density via, for example, a gamma ray or X-ray measurement device;
make the mineral (11) in the transport system (10), after going a certain distance (d2) from the second set of equipment (30), pass through a third set of measurement equipment (40), to determine its hydrogen content via, for example, a device for the measurement of fast neutrons, such as AmBe or PuBe;
synchronize the measurement times of the respective parameters in accordance with the distances (d1 and d2) to be traveled by the mineral (11) between sets of equipment and the speed of the transport system;
send the values measured to a microprocessor (50) containing an embedded computer program in order for the hydro carbonate content to be calculated in real time;
make the adjustments necessary in the processing operation conditions before the mineral is processed.

10. METHOD FOR MEASURING HYDRO CARBONATE CONTENT IN MINERALS, according to claim 9, characterized by creating an increase of 2% to 6% in the production of equivalent oil.

11. METHOD FOR MEASURING HYDRO CARBONATE CONTENT IN MINERALS, according to claim 9, characterized by submitting pyrobituminous shale minerals to the pyrolysis process.

12. METHOD FOR MEASURING HYDRO CARBONATE CONTENT IN MINERALS, according to claim 9, characterized by submitting pyrobituminous shale minerals to a combustion process.
